(19) United States
(12) Patent Application Publication
(10) Pub. No.: US 2025/0113321 A1
(43) Pub. Date: Apr. 3, 2025

(54) NON-PUBLIC NETWORK SELECTION

(71) Applicant: QUALCOMM Incorporated, San Diego, CA (US)

(72) Inventors: Sebastian SPEICHER, Wallisellen (CH); Haris ZISIMOPOULOS, London (GB); Miguel GRIOT, La Jolla, CA (US)

(21) Appl. No.: 18/833,103

(22) PCT Filed: Mar. 22, 2023
(86) PCT No.: PCT/US2023/015924

§ 371 Date: Jul. 25, 2024

(30) Foreign Application Priority Data
Mar. 29, 2022 (GR) 20220100275

(51) Int. Cl. H04W 60/00; H04W 48/18

(52) U.S. Cl. CPC H04W 60/00; H04W 48/18

(57) ABSTRACT

Various aspects of the present disclosure generally relate to wireless communication. In some aspects, an apparatus may receive a configuration indicating a set of non-public networks (NPNs), wherein the configuration includes at least one of: a time condition for accessing the set of NPNs, or a location condition for accessing the set of NPNs. The apparatus may scanning for the set of NPNs based at least in part on the configuration. The apparatus may register with an available NPN, of the set of NPNs, based at least in part on the time condition or the location condition being met for the available NPN. Numerous other aspects are described.

### CROSS-REFERENCE TO RELATED APPLICATION

This patent application claims priority to Greek patent application Ser. No. 20/220,100275, filed on Mar. 29, 2022, entitled “NON-PUBLIC NETWORK SELECTION,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for non-public network (NPN) selection.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

A method of wireless communication performed by an apparatus may include receiving a configuration indicating a set of non-public networks (NPNs), wherein the configuration includes at least one of a time condition for accessing the set of NPNs, or a location condition for accessing the set of NPNs; scanning for the set of NPNs based at least in part on the configuration; and registering with an available NPN, of the set of NPNs, based at least in part on the time condition or the location condition being met for the available NPN.

An apparatus for wireless communication may include a memory; and one or more processors, coupled to the memory, configured to cause the apparatus to receive a configuration indicating a set of NPNs, wherein the configuration includes at least one of a time condition for accessing the set of NPNs, or a location condition for accessing the set of NPNs; scan for the set of NPNs based at least in part on the configuration; and register with an available NPN, of the set of NPNs, based at least in part on the time condition or the location condition being met for the available NPN.

A non-transitory computer-readable medium may store a set of instructions for wireless communication, the set of instructions comprising one or more instructions that, when executed by one or more processors of an apparatus, cause the apparatus to receive a configuration indicating a set of NPNs, wherein the configuration includes at least one of a time condition for accessing the set of NPNs, or a location condition for accessing the set of NPNs; scan for the set of NPNs based at least in part on the configuration; and register with an available NPN, of the set of NPNs, based at least in part on the time condition or the location condition being met for the available NPN.

An apparatus for wireless communication, comprising means for receiving a configuration indicating a set of NPNs, wherein the configuration includes at least one of a time condition for accessing the set of NPNs, or a location condition for accessing the set of NPNs; means for scanning for the set of NPNs based at least in part on the configuration; and means for registering with an available NPN, of the set of NPNs, based at least in part on the time condition or the location condition being met for the available NPN.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a standalone non-public network (SNPN), in accordance with the present disclosure.

FIG. 4 is a diagram illustrating an example of configuration of a UE for discovery and selection of a non-public network for access to localized services, in accordance with the present disclosure.

FIG. 5 is a diagram illustrating an example of discovery and selection of SNPNs for access to localized services, in accordance with the present disclosure.

FIG. 6 is a diagram illustrating an example of discovery and selection of SNPNs for access to localized services, in accordance with the present disclosure.

FIG. 7 is a diagram illustrating an example of discovery and selection of public network integrated non-public networks for access to localized services, in accordance with the present disclosure.

FIG. 8 is a diagram illustrating an example process performed, for example, by an apparatus, in accordance with the present disclosure.

FIG. 9 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

A user equipment (UE) may register with a network in order to access a service (e.g., a localized service) via the network. For example, the UE may discover the network, and may communicate with a network entity of the network in order to be authenticated and to configure a connection with the network. The UE may use an access mode to discover and connect to the network. For example, the UE may use a public land mobile network (PLMN) access mode to discover and connect to a PLMN (or a public network integrated non-public network (NPN) supported by the PLMN). As another example, the UE may use a standalone NPN (SNPN) access mode to discover and connect to a subscribed SNPN of the UE. In the PLMN access mode, the UE may scan for and access a home PLMN of the UE. In the SNPN access mode, the UE may scan for and access a subscribed SNPN of the UE.

There are situations where it may be beneficial for the UE to access an NPN, such as an SNPN, other than a subscribed SNPN of the UE. For example, connecting to such an NPN may facilitate access to a localized service by the UE. However, the UE may prioritize a home PLMN in the PLMN access mode and may prioritize subscribed SNPN(s) in the SNPN access mode. If the NPN is deprioritized in such modes, the UE may be unlikely to connect to the NPN while in the SNPN access mode or the PLMN access mode. Furthermore, the PLMN access mode and the SNPN access mode have traditionally provided no way to restrict access beyond the credentials afforded to the UE, which is restrictive of certain forms of select access for localized services (e.g., time-based access, location-based access, sub-network identifier based access).

Some techniques and apparatuses described herein provide configuration of a UE to access a set of SNPNs or public network integrated NPNs, such as a set of NPNs associated with a localized service. For example, the configuration may indicate a set of NPNs, and a time condition and/or location condition associated with accessing the set of NPNs. The UE may scan for the set of NPNs based at least in part on the configuration. For example, the UE may scan for NPNs for which the time condition and/or the location condition is satisfied. In some aspects, the UE may access such NPNs in a mode where the set of NPNs identified by the configuration are prioritized over other NPNs and/or PLMNs. Thus, access to the set of NPNs, such as to facilitate access to localized services, is prioritized over access to a subscribed SNPN or a home PLMN of the UE. Furthermore, access to the set of NPNs can be restricted based at least in part on one or more conditions, such as a location condition, a time condition, or a combination thereof. Thus, access to a localized service hosted by an NPN can be restricted, which may assist with load balancing, location-specific or time-specific service offerings, and so on. Still further, the time condition and/or location condition may reduce overhead relative to managing time-based or location-based access by explicit reconfiguration of UEs, such as by removing or denying credentials when a time window has elapsed.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

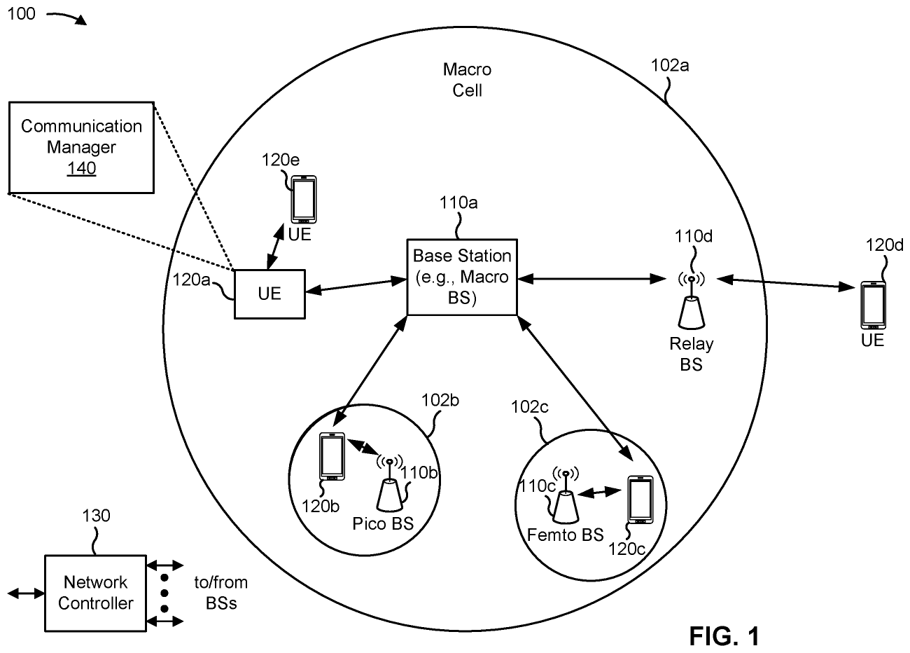

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, a base station, or a network equipment may be implemented in an aggregated or disaggregated architecture. For example, a base station (such as a Node B (NB), evolved NB (eNB), NR base station (BS), 5G NB, gNodeB (gNB), access point (AP), TRP, or cell), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more central units (CUs), one or more distributed units (DUs), one or more radio units (RUs), or a combination thereof).

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also may be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that may be individually deployed. A disaggregated base station may include functionality implemented across two or more units at various physical locations, as well as functionality implemented for at least one unit virtually, which may enable flexibility in network design. The various units of the disaggregated base station may be configured for wired or wireless communication with at least one other unit of the disaggregated base station.

In some aspects, an apparatus such as a UE 120 may include a communication manager 140. As described in more detail elsewhere herein, the communication manager 140 may receive a configuration indicating a set of non-public networks (NPNs), wherein the configuration includes at least one of: a time condition for accessing the set of NPNs, or a location condition for accessing the set of NPNs; scanning for the set of NPNs based at least in part on the configuration; and register with an available NPN, of the set of NPNs, based at least in part on the time condition or the location condition being met for the available NPN. Additionally, or alternatively, the communication manager 140 may perform one or more other operations described herein.

As indicated above, FIG. 1 is provided as an example. Other examples may differ from what is described with regard to FIG. 1.

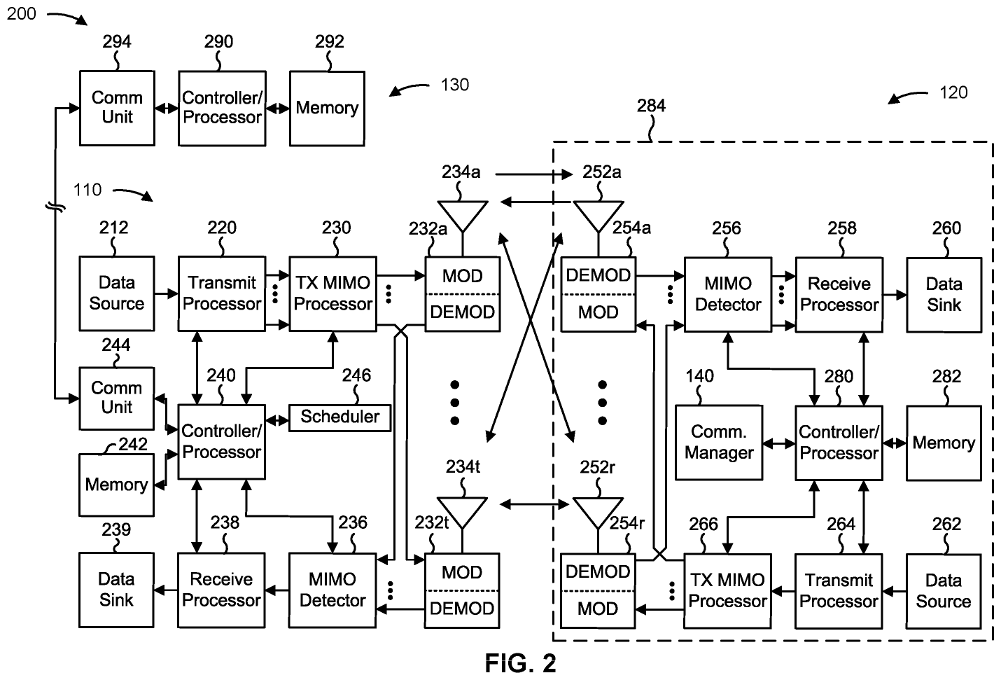

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

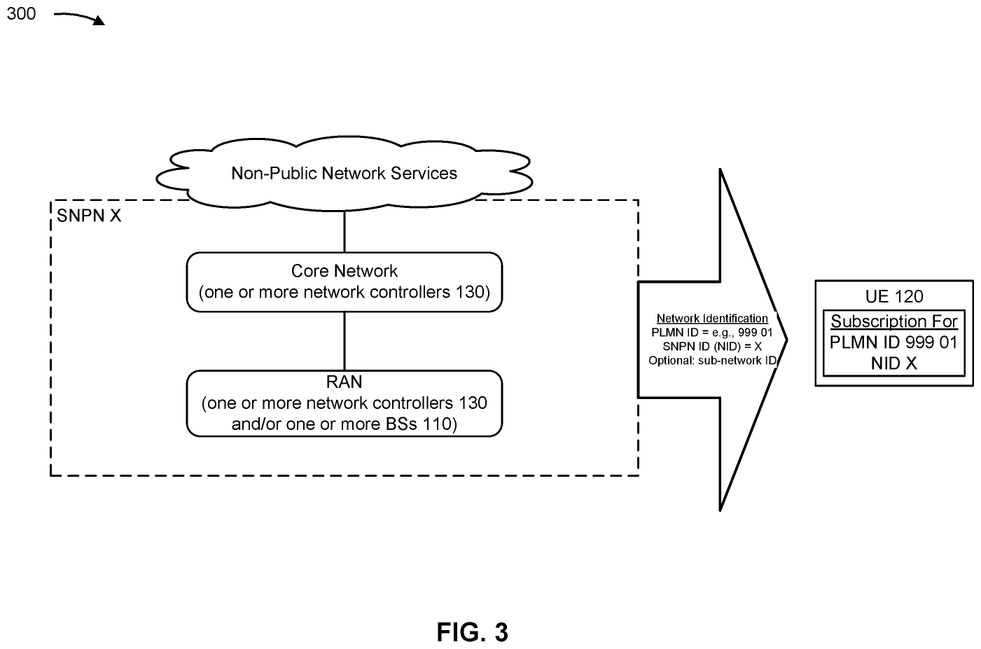

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-9).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-9).

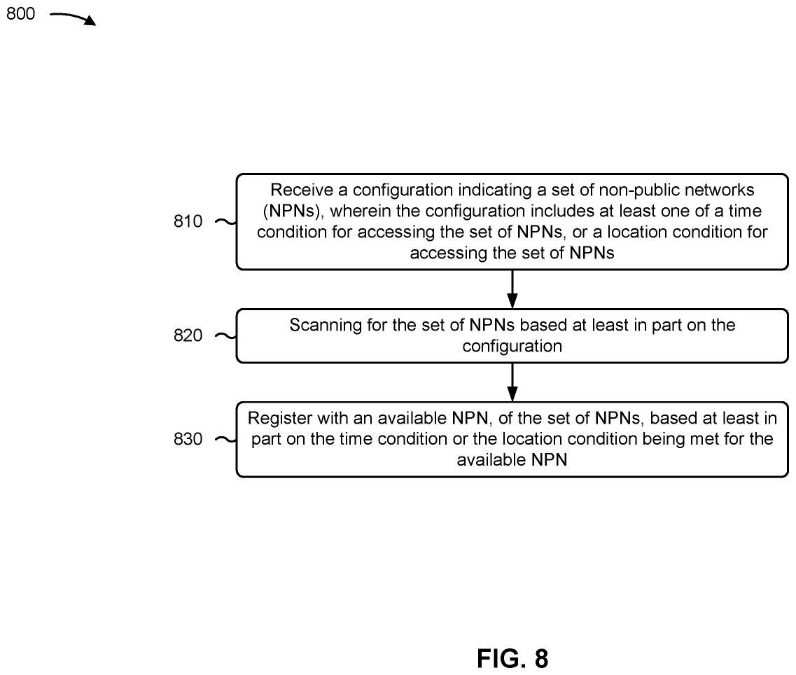

The controller/processor 240 of the base station 110, the controller/processor 280 of the UE 120, and/or any other component(s) of FIG. 2 may perform one or more techniques associated with accessing non-public networks, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, and/or other processes as described herein. In some examples, executing instructions may include running the instructions, converting the instructions, compiling the instructions, and/or interpreting the instructions, among other examples.

In some aspects, the apparatus includes means for receiving a configuration indicating a set of NPNs, wherein the configuration includes at least one of: a time condition for accessing the set of NPNs, or a location condition for accessing the set of NPNs; scanning for the set of NPNs based at least in part on the configuration; and/or means for registering with an available NPN, of the set of NPNs, based at least in part on the time condition or the location condition being met for the available NPN. In some aspects, the means for the apparatus to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of a standalone non-public network (SNPN), in accordance with various aspects of the present disclosure. An SNPN is a type of NPN. An SNPN is a dedicated, private wireless network (e.g., a 5G network or another type of wireless network) that may be associated with an enterprise, a facility, or another entity or site. For example, an SNPN may be associated with a particular corporate campus, a particular factory, a particular industrial facility, an event venue, and/or the like.

As shown in FIG. 3, an SNPN (e.g., referred to as SNPN X in FIG. 3) may be implemented in and by a wireless network. In this case, a core network and a RAN may be configured to provide the SNPN to the UE and/or other UEs that are permitted to access the SNPN.

The core network may include one or more network controllers 130 that provide various core network functions, such as a Network Slice Selection Function (NSSF), a Network Exposure Function (NEF), an Authentication Server Function (AUSF), a Unified Data Management (UDM) function, a Policy Control Function (PCF), an Application Function (AF), an Access and Mobility Management Function (AMF), a Session Management Function (SMF), a User Plane Function (UPF), an Inter-Working Function (IWF), and/or the like. The RAN may include one or more network controllers 130 and/or one or more BSs 110 that provide wireless coverage to UEs that access the home SP. In some aspects, the RAN may be implemented in a decentralized fashion, as described with regard to FIG. 1.

The UE may be associated with a home network, such as a subscribed SNPN or a home public land mobile network (PLMN). A subscribed SNPN is an SNPN that provides subscription information to the UE. The subscribed SNPN may be different from an SNPN that the UE is currently accessing (which may be referred to as a visited SNPN). The subscribed SNPN or the home PLMN may configure the UE with information relating to the subscription information, such as via a steering of roaming configuration. For example, the subscribed SNPN or home PLMN may provide the steering of roaming configuration via control plane signaling during registration, after registration, or the like. For example, the control plane signaling may include connected mode control information, such as steering or roaming connected mode control information (SOR-CMCI).

In some cases, access to the SNPN may be limited to UEs having subscriptions to the SNPN. In this case, a UE may be provisioned and/or otherwise configured with subscription information (e.g., a subscription permanent identifier (SUPI)) and/or a credential associated with the SNPN so that the UE can use the subscription information to register with the SNPN. As shown in FIG. 3, the subscription information may include a PLMN identifier associated with the home SP and an SNPN identifier (e.g., which may be referred to as a network identifier (NID)) associated with the SNPN. In some cases, the SNPN (e.g., one or more network entities in the SNPN) may configure the UE with the subscription information as part of a subscriber identity module (SIM) over-the-air (OTA) update procedure and/or another type of provisioning procedure. The UE may receive the subscription information and may store the subscription information in a SIM component, a universal integrated circuit card (UICC) component, and/or another component configured to store subscription information. In some cases, the UE may be deployed with a SIM component or UICC component that is already configured with the subscription information.

To access the SNPN, the UE may scan or monitor for transmissions that identify the PLMN identifier and the NID of the SNPN. For example, the SNPN (e.g., one or more network entities in the SNPN) may broadcast and/or otherwise transmit the PLMN identifier and the NID of the SNPN so that UEs may discover the SNPN. The UE may determine whether the PLMN identifier and the NID identified in the broadcast or transmission from the SNPN matches the PLMN identifier and the NID in the subscription information stored by the UE. If the PLMN identifier and the NID match, the UE may attempt to register with the SNPN. In some examples, the SNPN may broadcast one or more sub-network identifiers, which the UE may check against the subscription information stored by the UE, as described elsewhere herein.

Once the UE has registered with the SNPN, the SNPN may grant the UE access to various non-public network services hosted by the SNPN. In some aspects, the SNPN may be a local hosting NPN that hosts a service. For example, the UE may access a localized service via the SNPN. A localized service is a service access via an NPN, such as a video service, a data service, a voice calling service, a gaming service, or the like.

Another type of NPN is a public network integrated NPN (PNI-NPN). A PNI-NPN is an NPN that is deployed with the support of an PLMN. A PNI-NPN may be identified by a PLMN identifier and a closed access group (CAG) identifier. A CAG identifier identifies the set of CAG cells belonging to the PNI-NPN. A CAG cell may broadcast one or more CAG identifiers per PLMN. Network selection and reselection may be based at least in part on the PLMN ID. Cell selection and reselection and access control may be based at least in part on the CAG identifier. The CAG cell may broadcast information such that only UEs supporting CAG are accessing the cell.

As indicated above, FIG. 3 is provided as an example. Other examples may differ from what is described with respect to FIG. 3.

A UE may register with a network in order to access a service (e.g., a localized service) via the network. For example, the UE may discover the network, and may communicate with a network entity of the network in order to be authenticated and to configure a connection with the network. The UE may use an access mode to discover and connect to the network. For example, the UE may use a PLMN access mode to discover and connect to a PLMN (or a PNI-NPN supported by the PLMN). As another example, the UE may use an SNPN access mode to discover and connect to a subscribed SNPN of the UE. In the PLMN access mode, the UE may scan for and access a home PLMN of the UE. In the SNPN access mode, the UE may scan for and access a subscribed SNPN of the UE.

There are situations where it may be beneficial for the UE to access an NPN, such as an SNPN, other than a subscribed SNPN of the UE. For example, connecting to such an NPN may facilitate access to a localized service by the UE. However, the UE may prioritize a home PLMN in the PLMN access mode and may prioritize subscribed SNPN(s) in the SNPN access mode. If the NPN is deprioritized in such modes, the UE may be unlikely to connect to the NPN while in the SNPN access mode or the PLMN access mode. Furthermore, the PLMN access mode and the SNPN access mode have traditionally provided no way to restrict access beyond the credentials afforded to the UE, which is restrictive of certain forms of select access for localized services (e.g., time-based access, location-based access, sub-network identifier based access).

Some techniques and apparatuses described herein provide configuration of a UE to access a set of SNPNs or PNI-NPNs, such as a set of NPNs associated with a localized service. For example, the configuration may indicate a set of NPNs, and a time condition and/or location condition associated with accessing the set of NPNs. The UE may scan for the set of NPNs based at least in part on the configuration. For example, the UE may scan for NPNs for which the time condition and/or the location condition is satisfied. In some aspects, the UE may access such NPNs in a mode where the set of NPNs identified by the configuration are prioritized over other NPNs and/or PLMNs. Thus, access to the set of NPNs, such as to facilitate access to localized services, is prioritized over access to a subscribed SNPN or a home PLMN of the UE. Furthermore, access to the set of NPNs can be restricted based at least in part on one or more conditions, such as a location condition, a time condition, or a combination thereof. Thus, access to a localized service hosted by an NPN can be restricted, which may assist with load balancing, location-specific or time-specific service offerings, and so on. Still further, the time condition and/or location condition may reduce overhead relative to managing time-based or location-based access by explicit reconfiguration of UEs, such as by removing or denying credentials when a time window has elapsed.

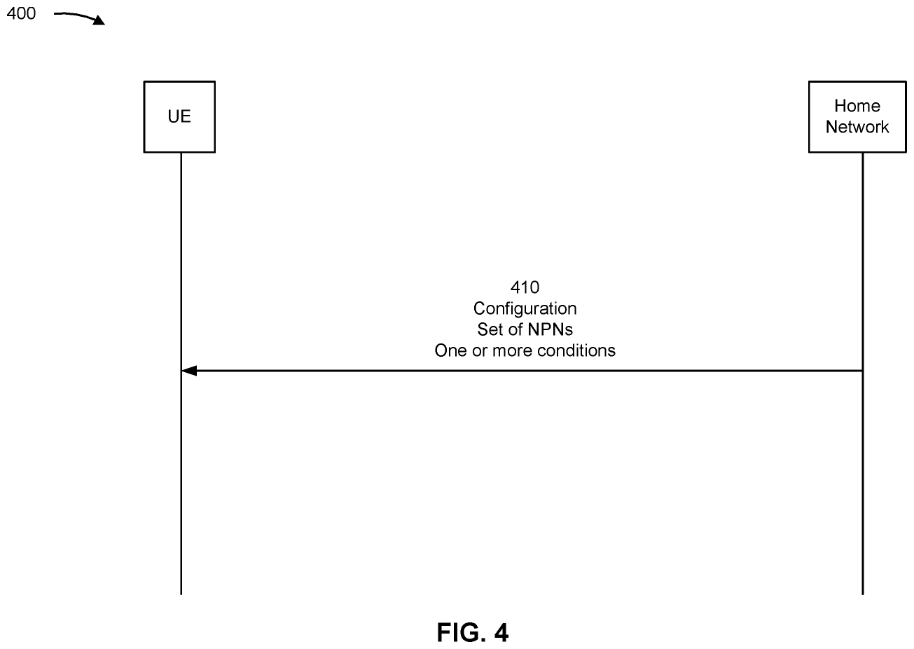

FIG. 4 is a diagram illustrating an example 400 of configuration of a UE for discovery and selection of SNPNs or CAG cells of a PNI-NPN for access to localized services, in accordance with the present disclosure. As shown, example 400 may include an apparatus (shown in FIG. 4 as a UE) and a home network of the UE. In some aspects, the home network may be a subscribed SNPN of the UE. In some aspects, the home network may be a home PLMN of the UE.

As shown in FIG. 4, and by reference number 410, the home network (e.g., a network entity associated with the home network) may transmit, and the UE may receive, a configuration. In some aspects, the home network may transmit the configuration to the UE based at least in part on the UE being in a particular mode. For example, the mode may be a mode in which accessing localized services via an SNPN is enabled. In some aspects, the home network may transmit the configuration to the UE based at least in part on the UE being an SNPN-localized services-enabled UE. An SNPN-localized services-enabled UE is a UE that supports access to localized services in SNPNs and/or that has been configured (or is configurable) to access a localized service via an SNPN. In some aspects, the UE may be pre-configured with the configuration (such as by an original equipment manufacturer, an implementer of the UE, or the like). Additionally, or alternatively, the UE can be dynamically configured with the configuration, such as using a steering of roaming configuration procedure or the like.

The configuration may indicate a set of NPNs. For example, the configuration may include a list of one or more NPNs. In some aspects, the set of NPNs may include a set of SNPNs. In some aspects, the set of NPNs may include one or more PNI-NPNs. For example, the configuration may include an allowed CAG list. An allowed CAG list may identify a set of CAG cells associated with one or more PNI-NPNs, such as a set of CAG cells associated with one PNI-NPN, a first set of CAG cells associated with a first PNI-NPN and a second set of CAG cells associated with a second PNI-NPN, or the like. In some aspects, the configuration may prioritize the set of NPNs. For example, a first NPN (or CAG cell) of the set of NPNs may be associated with a highest priority (such that the UE scans for or registers with the first NPN (or CAG cell) over any other NPN or CAG cell of the set of NPNs or CAG cells), a second NPN of the set of NPNs may be associated with a second-highest priority, and so on. Thus, in some examples, the configuration may be referred to as a prioritized list of SNPNs for localized services. In some aspects, the configuration may identify an NPN based at least in part on an SNPN identifier (which may include a PLMN identifier and a NIDO). In some aspects, the configuration may identify an NPN based at least in part on a group identifier for network selection (GIN). In some aspects, the configuration may identify a CAG cell of an NPN. If the configuration identifies a set of CAG cells, the configuration can be said to identify an NPN (e.g., a PNI-NPN associated with the set of CAG cells).

In some aspects, the set of NPNs may be associated with a localized service. For example, each NPN of the set of NPNs may provide access to the same localized service. As another example, each NPN of the set of NPNs may provide access to at least one localized service (where different NPNs can provide access to the same localized service, or different NPNs can provide access to different services, or a combination thereof).

In some aspects, the configuration may be associated with a subscription of the UE. For example, the configuration may be stored in a context of a given subscription of the UE. If the UE has multiple subscriptions, then the UE may be configurable with a first configuration for a first subscription, a second configuration for a second subscription, and so on. Thus, the UE may have one prioritized list of NPNs (e.g., SNPNs) for localized services for each subscription.

In some aspects, the configuration may indicate one or more conditions. For example, the one or more conditions may be associated with scanning for and/or registering with an NPN of the set of NPNs identified by the configuration. In some aspects, there may be a respective condition for each NPN of the set of NPNs (e.g., one condition, or one set of conditions, per NPN). Additionally, or alternatively, a condition may be associated with multiple NPNs. For example, a given condition may apply to scanning for and/or registering with a first NPN and a second NPN.

In some aspects, the one or more conditions may include a time condition. A time condition may indicate a start time, a duration, an end time, a date, a recurring time window, a periodicity of a time window, a day of the week, and/or one or more other parameters that define a time or times at which a UE can scan for and/or register with an NPN. In some aspects, the one or more conditions may include a location condition. A location condition may indicate location information (such as based at least in part on a tracking area, a list of tracking areas, geographic location information, device orientation information, or the like). If the UE satisfies the location condition (e.g., if one or more location parameters of the UE satisfy a criterion for location information defined by the location condition), then the UE may be permitted to scan for and/or access an NPN associated with the location condition. In some aspects, the one or more conditions may include a condition in addition to or as an alternative to a time condition and/or a location condition.

In some aspects, each entry in a prioritized list of SNPNs for localized services contains an SNPN ID (PLMN ID+NID) or a GIN and at least one of a time condition (including a from/to date and time) or a location condition (e.g., a list of tracking areas or geographic location information). In some aspects, entries in the allowed CAG list of the UE can additionally contain one or more of a time condition (including a from/to date and time) or a location condition (e.g., a list of tracking areas). In some examples, location information for an allowed CAG list may be needed only if a PNI-NPN as a hosting network can be a subset of a CAG.

In some aspects, the configuration may indicate one or more sub-network identifiers. A sub-network identifier is an identifier corresponding to a sub-network of an SNPN or a PNI-NPN. For example, a sub-network may be used to provide access to a localized service in a particular area within an SNPN or a PNI-NPN. In some examples, the configuration may indicate a sub-network identifier corresponding to an SNPN. For example, each entry in a prioritized list of SNPNs or PNI-NPNs for localized services may be permitted to contain a sub-network identifier in addition to the SNPN identifier. The sub-network identifier may be considered a condition associated with an SNPN. For example, if the UE detects an SNPN, of a prioritized list of SNPNs, that is broadcasting a particular sub-network identifier, the UE may register with the SNPN only if the prioritized list of SNPNs indicates that the particular sub-network identifier is associated with the SNPN. For example, the sub-network identifier may be broadcast by an SNPN hosting the sub-network (in addition to SNPN ID and optionally the GIN). If an entry in the prioritized list of SNPNs (or PNI-NPNs) for localized services also contains a sub-network identifier, then the UE only considers the entry a match with an available and allowable SNPN if the broadcasted SNPN ID from the available SNPN matches the SNPN ID in the list entry and if the SNPN broadcasts a sub-network identifier value that matches the sub-network identifier in the list entry. An SNPN or PNI-NPN may be considered available and allowable if the UE discovers the SNPN or PNI-NPN based at least in part on discovery information, and the discovery information (and/or information stored by the UE) indicates that the UE is permitted to register with the SNPN or PNI-NPN.

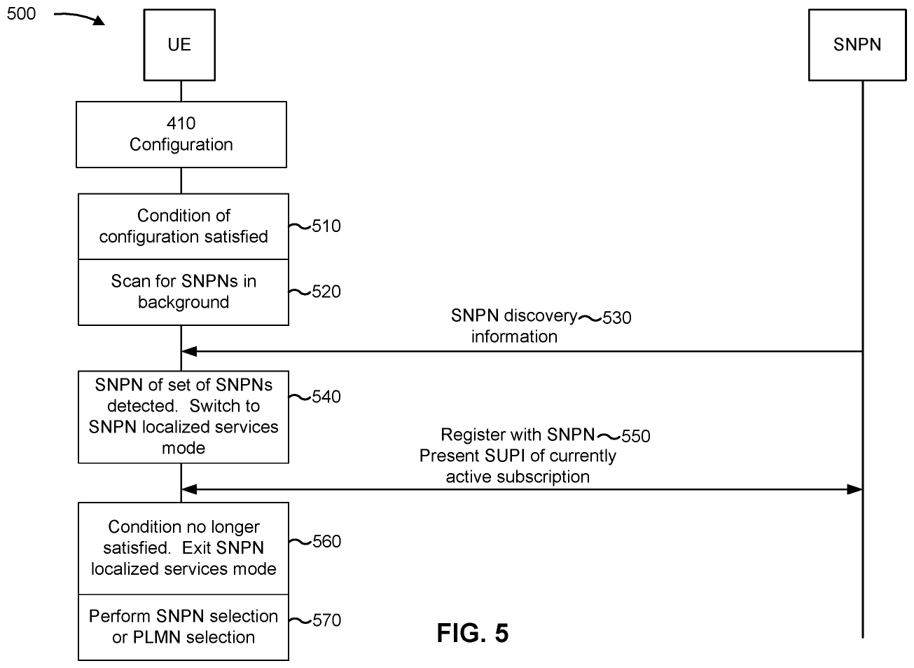

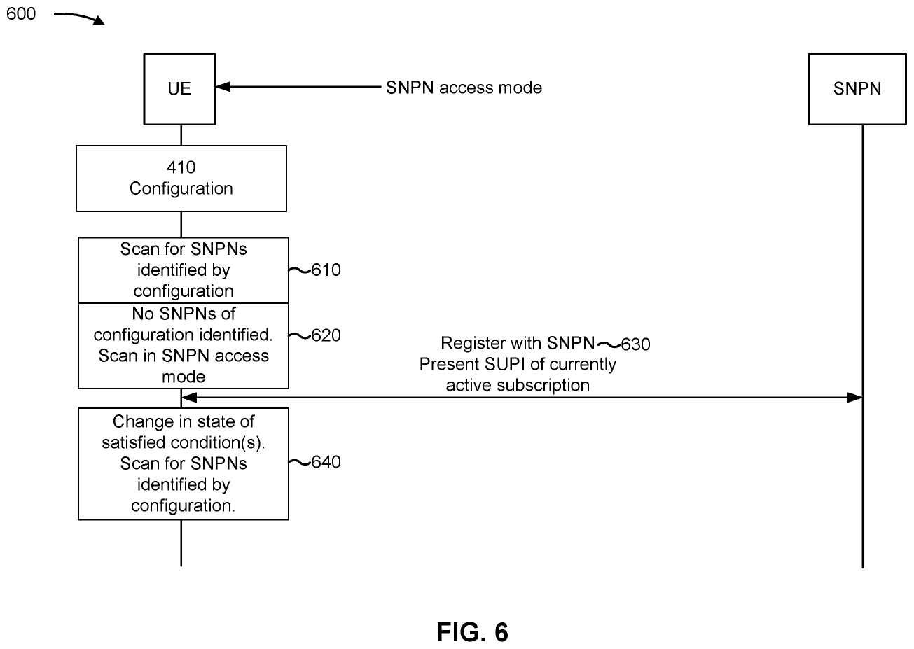

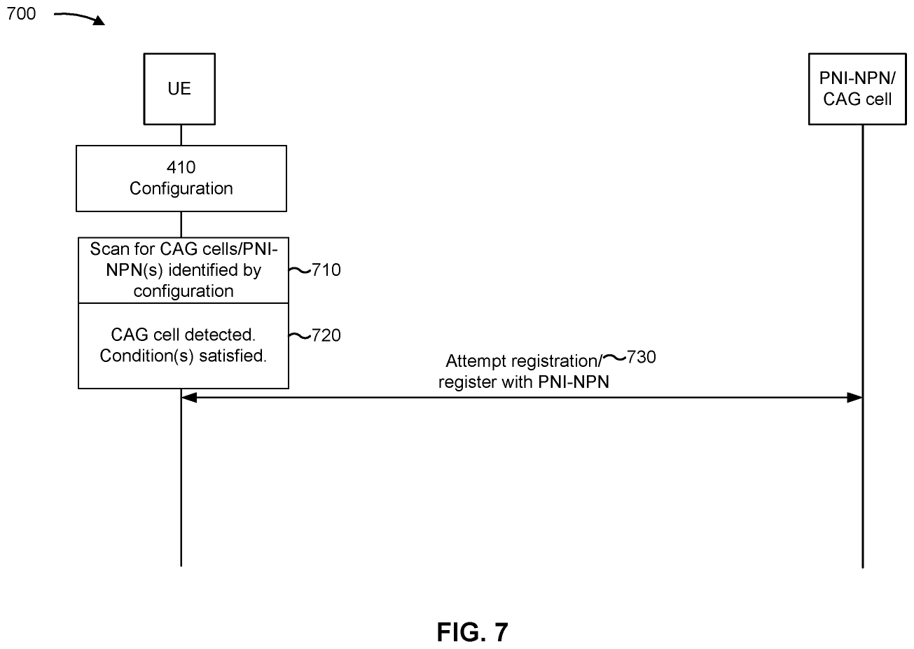

At least part of the configuration described with regard to FIG. 4 may be used in example 500 of FIG. 5, example 600 of FIG. 6, and/or example 700 of FIG. 7.

As indicated above, FIG. 4 is provided as an example. Other examples may differ from what is described with regard to FIG. 4.

FIG. 5 is a diagram illustrating an example 500 of discovery and selection of SNPNs for access to localized services, in accordance with the present disclosure. As shown, example 500 includes an apparatus (illustrated and described in example 500 as a UE) and an SNPN. The SNPN depicted in FIG. 5 may represent one or more network entities associated with the SNPN, such as a RAN associated with the SNPN and/or a core network entity of the SNPN. In example 500, the UE may initially be in an SNPN access mode or a PLMN access mode. In an SNPN access mode, the UE may scan for subscribed SNPNs of the UE and will ignore available PLMNs. In a PLMN access mode, the UE may scan for PLMNs on which the UE can register.

As shown, the UE may have a configuration, as described in more detail in connection with reference number 410 of FIG. 4. For example, the UE may be preconfigured with the configuration, or may be dynamically configured with the configuration. As mentioned above, the configuration may indicate a set of NPNs (in example 500, at least a list of SNPNs), and one or more conditions (e.g., one or more time conditions, one or more location conditions, a sub-network identifier, or a combination thereof) associated with the set of NPNs. For the purposes of example 500, the set of NPNs is referred to hereinafter as a set of SNPNs.

As shown by reference number 510, a condition identified by the configuration may be satisfied. For example, the UE may determine that the condition is satisfied. The condition may correspond to one or more NPNs of the set of NPNs. For example, the configuration may correspond to a specific NPN of the set of NPNs. As another example, the condition may correspond to all NPNs of the set of NPNs.

As shown by reference number 520, the UE may scan for SNPNs. For example, the UE may scan for SNPNs of the set of SNPNs. In some aspects, the UE may scan for only SNPNs that are associated with the satisfied condition. In some other aspects, the UE may scan for any SNPN of the set of SNPNs. In some aspects, the UE may scan for SNPNs in the background. For example, the UE may scan for SNPNs, belonging to the set of SNPNs, while the UE is in SNPN access mode or PLMN access mode. As used herein, “scanning for an NPN” (such as an SNPN or a CAG cell) may refer to monitoring for (e.g., attempting to receive or decode) discovery information transmitted by the NPN for discovery or registration of the NPN, such as system information identifying the NPN or the like. The discovery information is shown by reference number 530. In some aspects, the discovery information may include a sub-network identifier, and the UE may selectively register with an SNPN based at least in part on the sub-network identifier, as described in connection with FIG. 4.

In some aspects, the UE may scan for SNPNs in the background based at least in part on the UE being configured with a prioritized list of SNPNs for localized services, and based at least in part on at least one condition, of the one or more conditions, being met. In some aspects, this may apply to an SNPN-localized services-enabled UE while the UE is in SNPN access mode or PLMN access mode. In some aspects, the UE may scan based at least in part on an implementation of the UE.

As shown by reference number 540, the UE may detect an SNPN of the set of SNPNs. For example, the UE may detect at least one available and allowable SNPN, of the set of SNPNs, that meets the satisfied condition. In other words, the UE may identify an SNPN that is associated with a condition that is satisfied (e.g., the UE is associated with a location that satisfies the location condition, the UE is associated with a time that satisfies the time condition, or the like), and that the UE is allowed to access.

As shown, the UE may switch to an SNPN localized services mode. For example, the UE may switch to the SNPN localized services mode based at least in part on detecting at least one SNPN, of the set of SNPNs, for which the condition is satisfied. The SNPN localized services mode is a mode in which the UE prioritizes selection of an available SNPN of the set of SNPNs. For example, the UE may exit an SNPN access mode (in which the UE prioritizes selection of subscribed SNPNs) or a PLMN access mode (in which the UE prioritizes selection of a PLMN), and may enter the SNPN localized services mode. In some aspects, the UE may switch to the SNPN localized services mode based at least in part on detecting an SNPN with a sub-network identifier that matches the SNPN's sub-network identifier as indicated by the configuration.

As shown by reference number 550, the UE may register with an SNPN of the set of SNPNs. For example, the UE may select an available SNPN of the set of SNPNs identified by the configuration. The UE may perform initial registration with the selected SNPN. The UE may present, to the selected SNPN, an SUPI of a currently available subscription. For example, the UE may present an SUPI of a subscription whose context stores the configuration indicating the SNPNs used to select the selected SNPN. In some aspects, the UE may access a localized service provided by the selected SNPN. For example, the UE may receive or transmit data or other communications associated with the local service via the selected SNPN. In some aspects, the UE may register with the SNPN based at least in part on the SNPN's sub-network identifier being indicated by the configuration as being associated with the SNPN.

As shown by reference number 560, a condition may cease to be satisfied. For example, the UE may determine that a condition associated with the set of NPNs, satisfied as described at reference number 510, is no longer satisfied. For example, the condition may cease to be satisfied based at least in part on a time window in which the UE is allowed to access the selected SNPN ending, based at least in part on a location of the UE changing such that the location condition is no longer satisfied, or the like. As further shown, the UE may exit the SNPN localized services mode based at least in part on the condition ceasing to be satisfied. For example, the UE may exit the SNPN localized services mode based at least in part on determining that the condition is no longer satisfied. In some aspects, the UE may switch to an SNPN access mode or a PLMN access mode (e.g., whichever access mode the UE was in before switching to the SNPN localized services mode). Thus, the UE may perform SNPN selection and/or scanning, or PLMN selection and/or scanning, after switching out of the SNPN localized services mode, as shown by reference number 570. For example, if the conditions in the prioritized list of SNPNs for localized services for the currently registered SNPN are no longer met, then the UE may disable the SNPN localized services mode and may return to the mode in which the UE was operating before activating SNPN Localized services mode (i.e., return to SNPN access mode or PLMN access mode), and may performs SNPN selection or PLMN selection.

As indicated above, FIG. 5 is provided as an example. Other examples may differ from what is described with regard to FIG. 5.

FIG. 6 is a diagram illustrating an example 600 of discovery and selection of SNPNs for access to localized services, in accordance with the present disclosure. As shown, example 600 includes an apparatus (illustrated and described in example 600 as a UE) and an SNPN. The SNPN depicted in FIG. 6 may represent one or more network entities associated with the SNPN, such as a RAN associated with the SNPN and/or a core network entity of the SNPN. In example 600, the UE is in SNPN access mode.

As shown, the UE may have a configuration, as described in more detail in connection with reference number 410 of FIG. 4. For example, the UE may be preconfigured with the configuration, or may be dynamically configured with the configuration. As mentioned above, the configuration may indicate a set of NPNs (in example 500, at least a list of SNPNs), and one or more conditions (e.g., one or more time conditions, one or more location conditions, a sub-network identifier, or a combination thereof) associated with the set of NPNs. For the purposes of example 600, the set of NPNs is referred to hereinafter as a set of SNPNs.

As shown by reference number 610, the UE, while in SNPN access mode, may scan for SNPNs identified by the configuration. For example, the UE may scan for SNPNs, of the set of SNPNs, based at least in part on a condition associated with the configuration being satisfied. In other words, the UE may scan for SNPNs which broadcast an SNPN ID or GIN that matches an entry in the prioritized list of SNPNs for access to localized services (identified by the configuration) and for which the condition(s) of the related entry of the prioritized list are satisfied (and optionally, which has a sub-network identifier indicated by the configuration).

As shown by reference number 620, if the UE does not detect an SNPN identified by the configuration, the UE may continue scanning for SNPNs in the SNPN access mode. For example, if the UE cannot find a matching SNPN identified by the configuration, then the UE may continue scanning for SNPNs in accordance with a procedure for the SNPN access mode. Thus, the SNPN access mode may be modified such that the UE first scans for SNPNs identified by the configuration, and if no acceptable SNPNs identified by the configuration are detected, the UE may proceed to search for other SNPNs in accordance with the SNPN access mode. As shown by reference number 630, if the UE detects an available SNPN as part of the SNPN access mode, the UE may register with the SNPN, such as based at least in part on presenting a SUPI of the UE's currently active subscription. If the UE detected an available SNPN, of the set of SNPNs, for which a corresponding condition is satisfied, the UE may register with the detected SNPN, as described in connection with FIG. 5.

As shown by reference number 640, the UE may identify a change in state of one or more satisfied conditions of the one or more conditions identified by the configuration. For example, the UE may determine that a condition, which was not previously satisfied, is now satisfied. As another example, the UE may determine that a condition, which was previously satisfied (such as at reference number 610), is no longer satisfied. Thus, the UE may initiate scanning for SNPNs of the set of SNPNs identified by the configuration. For example, the UE may return to reference number 610. In other words, the UE may (e.g., shall) continuously evaluate the conditions of the entries in the prioritized list of SNPNs for localized services. If the conditions of any of the entries changes so that an entry becomes valid that was previously invalid (or vice versa), then the UE may (e.g., shall) perform SNPN selection again.

In some aspects, the UE may have a PLMN subscription and may be in PLMN access mode (e.g., not SNPN access mode). In such examples, if a UE is configured with a prioritized list of SNPNs for localized services and at least for one entry in the list of conditions are met (e.g., a current time is within an identified time period, a location of the UE satisfies a location condition, a sub-network identifier matches what is identified by the prioritized list of SNPNs), then the UE may for SNPNs in the background. For example, the fact that one of the conditions is met may be a trigger to perform background scanning for available SNPNs. If the UE finds at least one available and allowable SNPN which meets the conditions, then the UE may switch to SNPN access mode and may select an available SNPN from the list of SNPNs for localized services (such as using the procedure described with regard to reference numbers 610, 620, 630, and 640, starting at reference number 610). If the conditions for all entries in the prioritized list of SNPNs for localized services are no longer met or if no SNPNs matching any of the entries in the list are available and the UE was in PLMN access mode prior to switching to SNPN access mode, then the UE may return to PLMN access mode.

As indicated above, FIG. 6 is provided as an example. Other examples may differ from what is described with regard to FIG. 6.

FIG. 7 is a diagram illustrating an example 700 of discovery and selection of PNI-NPNs for access to localized services, in accordance with the present disclosure. As shown, example 700 includes an apparatus (illustrated and described in example 600 as a UE) and a PNI-NPN, such as a CAG cell belonging to or providing access to the PNI-NPN. The PNI-NPN depicted in FIG. 6 may represent one or more network entities associated with the PNI-NPN or the CAG cell, such as a radio access node associated with the CAG cell and/or a core network entity of the PNI-NPN.

As shown, the UE may have a configuration, as described in more detail in connection with reference number 410 of FIG. 4. For example, the UE may be preconfigured with the configuration, or may be dynamically configured with the configuration. As mentioned above, the configuration may indicate a set of NPNs (in example 700, at least a list of CAG cells such as an allowed CAG list), and one or more conditions (e.g., one or more time conditions, one or more location conditions, or a combination thereof) associated with the set of NPNs.

As shown by reference number 710, the UE may scan for CAG cells. For example, the UE may scan for CAG cells based at least in part on a condition indicated by the configuration being satisfied. As another example, the UE may scan for CAG cells irrespective of the condition indicated by the configuration being satisfied.

As shown by reference number 720, the UE may detect a CAG cell. For example, the UE may receive discovery information from the CAG cell. In some aspects, the UE may determine that a condition, indicated by the configuration and associated with the CAG cell and/or a PNI-NPN associated with the CAG cell, is satisfied. As shown by reference number 730, the UE may attempt registration on the CAG cell and/or a PNI-NPN associated with the CAG cell based at least in part on the configuration. For example, the UE may attempt registration if a condition, indicated by the configuration and associated with the CAG cell and/or the PNI-NPN associated with the CAG cell, is satisfied. In other words, the UE may only considers an entry in the allowed CAG list valid if and while all conditions associated with the entry are met. For example, a UE may only attempt registration on a CAG cell if, for example, the current time lies within the time period of the time condition associated with the CAG cell and/or the PNI-NPN. In some aspects, the UE may successfully register with the PNI-NPN and/or the CAG cell.

As indicated above, FIG. 7 is provided as an example. Other examples may differ from what is described with regard to FIG. 7.

FIG. 8 is a diagram illustrating an example process 800 performed, for example, by an apparatus, in accordance with the present disclosure. Example process 800 is an example where the apparatus (e.g., UE 120, the UE of FIGS. 4-7) performs operations associated with non-public network selection.

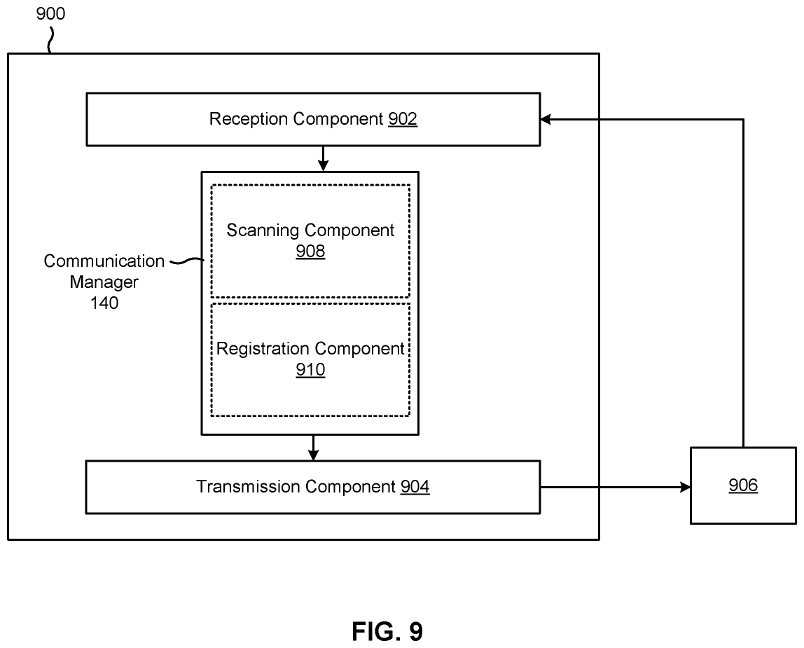

As shown in FIG. 8, in some aspects, process 800 may include receiving a configuration indicating a set of NPNs, wherein the configuration includes at least one of: a time condition for accessing the set of NPNs, or a location condition for accessing the set of NPNs (block 810). For example, the apparatus (e.g., using communication manager 140 and/or reception component 902, depicted in FIG. 9) may receive a configuration indicating a set of NPNs, wherein the configuration includes at least one of: a time condition for accessing the set of NPNs, or a location condition for accessing the set of NPNs, as described above, for example, with regard to reference number 410 of FIGS. 4-7.

As further shown in FIG. 8, in some aspects, process 800 may include scanning for the set of NPNs based at least in part on the configuration (block 820). For example, the apparatus (e.g., using communication manager 140 and/or scanning component 908, depicted in FIG. 9) may scanning for the set of NPNs based at least in part on the configuration, as described above, for example, with regard to reference number 520 of FIG. 5, reference numbers 610 and 620 of FIG. 6, and reference number 710 of FIG. 7.

As further shown in FIG. 8, in some aspects, process 800 may include registering with an available NPN, of the set of NPNs, based at least in part on the time condition or the location condition being met for the available NPN (block 830). For example, the apparatus (e.g., using communication manager 140 and/or registration component 910, depicted in FIG. 9) may register with an available NPN, of the set of NPNs, based at least in part on the time condition or the location condition being met for the available NPN, as described above, for example, with regard to reference number 550 of FIG. 5, reference number 630 of FIG. 6, and reference number 730 of FIG. 7.

Process 800 may include additional aspects, such as any single aspect or any combination of aspects described below and/or in connection with one or more other processes described elsewhere herein.

In a first aspect, the set of NPNs is a set of SNPNs, and scanning for the set of SNPNs based at least in part on the configuration further comprises scanning for the set of SNPNs while in a PLMN access mode based at least in part on the time condition or the location condition being satisfied.

In a second aspect, alone or in combination with the first aspect, process 800 includes detecting the available NPN based at least in part on the scanning, and switching to an SNPN localized services mode, wherein registering with the available NPN is based at least in part on the SNPN localized services mode.

In a third aspect, alone or in combination with one or more of the first and second aspects, process 800 includes switching from the SNPN localized services mode to a PLMN access mode or an SNPN access mode based at least in part on the time condition or the location condition no longer being satisfied.

In a fourth aspect, alone or in combination with one or more of the first through third aspects, in the SNPN localized services mode, the apparatus accesses only SNPNs of the set of SNPNs.

In a fifth aspect, alone or in combination with one or more of the first through fourth aspects, the set of NPNs is a set of SNPNs, and scanning for the set of SNPNs based at least in part on the configuration further comprises scanning for SNPNs broadcasting an SNPN identifier that matches an SNPN, of the set of SNPNs, for which the time condition or the location condition is satisfied.

In a sixth aspect, alone or in combination with one or more of the first through fifth aspects, scanning for the set of SNPNs further comprises initiating scanning for the set of SNPNs based at least in part on a change in whether the time condition is satisfied or a change in whether the location condition is satisfied.

In a seventh aspect, alone or in combination with one or more of the first through sixth aspects, the configuration indicates a set of sub-network identifiers associated with the set of NPNs, and registering with the available NPN further comprises registering with the available NPN based at least in part on the available NPN broadcasting a sub-network identifier, of the set of sub-network identifiers, that corresponds to the available NPN based at least in part on the configuration.

In an eighth aspect, alone or in combination with one or more of the first through seventh aspects, the configuration includes an allowed CAG list, and registering with the available NPN further comprises registering with a CAG cell, associated with the available NPN, based at least in part on the CAG cell being identified by the allowed CAG list and based at least in part on the time condition or the location condition being satisfied for the CAG cell.

In a ninth aspect, alone or in combination with one or more of the first through eighth aspects, the set of NPNs includes a set of PNI-NPNs.

In a tenth aspect, alone or in combination with one or more of the first through ninth aspects, the configuration is associated with a subscriber of the apparatus.

In a tenth aspect, alone or in combination with one or more of the first through ninth aspects, the subscriber is associated with a subscribed NPN or a home public land mobile network, and the configuration is received from the subscribed NPN or the home public land mobile network.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include one or more of a scanning component 908 or a registration component 910, among other examples.

In some aspects, the apparatus 900 may be configured to perform one or more operations described herein in connection with FIGS. 4-7. Additionally, or alternatively, the apparatus 900 may be configured to perform one or more processes described herein, such as process 800 of FIG. 8, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive a configuration indicating a set of NPNs, wherein the configuration includes at least one of a time condition for accessing the set of NPNs, or a location condition for accessing the set of NPNs. The scanning component 908 may scan for the set of NPNs based at least in part on the configuration. The registration component 910 may register with an available NPN, of the set of NPNs, based at least in part on the time condition or the location condition being met for the available NPN.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by an apparatus, comprising: receiving a configuration indicating a set of non-public networks (NPNs), wherein the configuration includes at least one of: a time condition for accessing the set of NPNs, or a location condition for accessing the set of NPNs; scanning for the set of NPNs based at least in part on the configuration; and registering with an available NPN, of the set of NPNs, based at least in part on the time condition or the location condition being met for the available NPN.
Aspect 2: The method of Aspect 1, wherein the set of NPNs is a set of standalone NPNs (SNPNs), and wherein scanning for the set of SNPNs based at least in part on the configuration further comprises: scanning for the set of SNPNs while in a public land mobile network (PLMN) access mode based at least in part on the time condition or the location condition being satisfied.
Aspect 3: The method of Aspect 2, further comprising: detecting the available NPN based at least in part on the scanning; and switching to an SNPN localized services mode, wherein registering with the available NPN is based at least in part on the SNPN localized services mode.
Aspect 4: The method of Aspect 3, further comprising: switching from the SNPN localized services mode to a PLMN access mode or an SNPN access mode based at least in part on the time condition or the location condition no longer being satisfied.
Aspect 5: The method of Aspect 3, wherein, in the SNPN localized services mode, the apparatus accesses only SNPNs of the set of SNPNs.
Aspect 6: The method of any of Aspects 1-5, wherein the set of NPNs is a set of standalone NPNs (SNPNs), and wherein scanning for the set of SNPNs based at least in part on the configuration further comprises: scanning for SNPNs broadcasting an SNPN identifier that matches an SNPN, of the set of SNPNs, for which the time condition or the location condition is satisfied.
Aspect 7: The method of Aspect 6, wherein scanning for the set of SNPNs further comprises: initiating scanning for the set of SNPNs based at least in part on a change in whether the time condition is satisfied or a change in whether the location condition is satisfied.
Aspect 8: The method of any of Aspects 1-7, wherein the configuration indicates a set of sub-network identifiers associated with the set of NPNs, and wherein registering with the available NPN further comprises: registering with the available NPN based at least in part on the available NPN broadcasting a sub-network identifier, of the set of sub-network identifiers, that corresponds to the available NPN based at least in part on the configuration.
Aspect 9: The method of Aspect 1, wherein the configuration includes an allowed closed access group (CAG) list, and wherein registering with the available NPN further comprises: registering with a CAG cell, associated with the available NPN, based at least in part on the CAG cell being identified by the allowed CAG list and based at least in part on the time condition or the location condition being satisfied for the CAG cell.
Aspect 10: The method of Aspect 9, wherein the set of NPNs includes a set of public network integrated NPNs (PNI-NPNs).
Aspect 11: The method of any of Aspects 1-10, wherein the configuration is associated with a subscriber of the apparatus.
Aspect 12: The method of Aspect 11, wherein the subscriber is associated with a subscribed NPN or a home public land mobile network, and wherein the configuration is received from the subscribed NPN or the home public land mobile network.
Aspect 13: An apparatus for wireless communication at a device, comprising a processor; memory coupled with the processor; and instructions stored in the memory and executable by the processor to cause the apparatus to perform the method of one or more of Aspects 1-12.
Aspect 14: A device for wireless communication, comprising a memory and one or more processors coupled to the memory, the one or more processors configured to perform the method of one or more of Aspects 1-12.
Aspect 15: An apparatus for wireless communication, comprising at least one means for performing the method of one or more of Aspects 1-12.
Aspect 16: A non-transitory computer-readable medium storing code for wireless communication, the code comprising instructions executable by a processor to perform the method of one or more of Aspects 1-12.
Aspect 17: A non-transitory computer-readable medium storing a set of instructions for wireless communication, the set of instructions comprising one or more instructions that, when executed by one or more processors of a device, cause the device to perform the method of one or more of Aspects 1-12.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication, comprising:
a memory; and
one or more processors, coupled to the memory, configured to cause the apparatus to:
receive a configuration indicating a set of non-public networks (NPNs), wherein the configuration includes at least one of:
a time condition for accessing the set of NPNs, or
a location condition for accessing the set of NPNs;
scan for the set of NPNs based at least in part on the configuration; and
register with an available NPN, of the set of NPNs, based at least in part on the time condition or the location condition being met for the available NPN.

2. The apparatus of claim 1, wherein the set of NPNs is a set of standalone NPNs (SNPNs), and wherein the one or more processors, to cause the apparatus to scan for the set of SNPNs based at least in part on the configuration, are configured to cause the apparatus to:
scan for the set of SNPNs while in a public land mobile network (PLMN) access mode based at least in part on the time condition or the location condition being satisfied.

3. The apparatus of claim 2, wherein the one or more processors are further configured to cause the apparatus to:
detect the available NPN based at least in part on the scanning; and
switch to an SNPN localized services mode, wherein registering with the available NPN is based at least in part on the SNPN localized services mode.

4. The apparatus of claim 3, wherein the one or more processors are further configured to cause the apparatus to:
switch from the SNPN localized services mode to a PLMN access mode or an SNPN access mode based at least in part on the time condition or the location condition no longer being satisfied.

5. The apparatus of claim 3, wherein, in the SNPN localized services mode, the apparatus is configured to register with only SNPNs of the set of SNPNs.

6. The apparatus of claim 1, wherein the set of NPNs is a set of standalone NPNs (SNPNs), and wherein the one or more processors, to cause the apparatus to scan for the set of SNPNs based at least in part on the configuration, are configured to cause the apparatus to:
scan for SNPNs broadcasting an SNPN identifier that matches an SNPN, of the set of SNPNs, for which the time condition or the location condition is satisfied.

7. The apparatus of claim 6, wherein the one or more processors, to cause the apparatus to scan for the set of SNPNs based at least in part on the configuration, are configured to cause the apparatus to:
initiate scanning for the set of SNPNs based at least in part on a change in whether the time condition is satisfied or a change in whether the location condition is satisfied.

8. The apparatus of claim 1, wherein the configuration indicates a set of sub-network identifiers associated with the set of NPNs, and wherein the one or more processors, to cause the apparatus to register with the available NPN, are configured to cause the apparatus to:
register with the available NPN based at least in part on the available NPN broadcasting a sub-network identifier, of the set of sub-network identifiers, that corresponds to the available NPN based at least in part on the configuration.

9. The apparatus of claim 1, wherein the configuration includes an allowed closed access group (CAG) list, and wherein the one or more processors, to cause the apparatus to register with the available NPN, are configured to cause the apparatus to:
register with a CAG cell, associated with the available NPN, based at least in part on the CAG cell being identified by the allowed CAG list and based at least in part on the time condition or the location condition being satisfied for the CAG cell.

10. The apparatus of claim 9, wherein the set of NPNs includes a set of public network integrated NPNs (PNI-NPNs).

11. The apparatus of claim 1, wherein the configuration is associated with a subscriber of the apparatus.

12. The apparatus of claim 11, wherein the subscriber is associated with a subscribed NPN or a home public land mobile network, and wherein the configuration is from the subscribed NPN or the home public land mobile network.

13. A method of wireless communication performed by an apparatus, comprising:
receiving a configuration indicating a set of non-public networks (NPNs), wherein the configuration includes at least one of:
a time condition for accessing the set of NPNs, or
a location condition for accessing the set of NPNs;
scanning for the set of NPNs based at least in part on the configuration; and
registering with an available NPN, of the set of NPNs, based at least in part on the time condition or the location condition being met for the available NPN.

14. The method of claim 13, wherein the set of NPNs is a set of standalone NPNs (SNPNs), and wherein scanning for the set of SNPNs based at least in part on the configuration further comprises:
scanning for the set of SNPNs while in a public land mobile network (PLMN) access mode based at least in part on the time condition or the location condition being satisfied.

15. The method of claim 14, further comprising:
detecting the available NPN based at least in part on the scanning; and
switching to an SNPN localized services mode, wherein registering with the available NPN is based at least in part on the SNPN localized services mode.

16. The method of claim 15, further comprising:
switching from the SNPN localized services mode to a PLMN access mode or an SNPN access mode based at least in part on the time condition or the location condition no longer being satisfied.

17. The method of claim 15, wherein, in the SNPN localized services mode, the apparatus accesses only SNPNs of the set of SNPNs.

18. The method of claim 13, wherein the set of NPNs is a set of standalone NPNs (SNPNs), and wherein scanning for the set of SNPNs based at least in part on the configuration further comprises:
scanning for SNPNs broadcasting an SNPN identifier that matches an SNPN, of the set of SNPNs, for which the time condition or the location condition is satisfied.

19. The method of claim 18, wherein scanning for the set of SNPNs further comprises:
initiating scanning for the set of SNPNs based at least in part on a change in whether the time condition is satisfied or a change in whether the location condition is satisfied.

20. The method of claim 13, wherein the configuration indicates a set of sub-network identifiers associated with the set of NPNs, and wherein registering with the available NPN further comprises:
registering with the available NPN based at least in part on the available NPN broadcasting a sub-network identifier, of the set of sub-network identifiers, that corresponds to the available NPN based at least in part on the configuration.

21. The method of claim 13, wherein the configuration includes an allowed closed access group (CAG) list, and wherein registering with the available NPN further comprises:
registering with a CAG cell, associated with the available NPN, based at least in part on the CAG cell being identified by the allowed CAG list and based at least in part on the time condition or the location condition being satisfied for the CAG cell.

22. The method of claim 21, wherein the set of NPNs includes a set of public network integrated NPNs (PNI-NPNs).

23. The method of claim 13, wherein the configuration is associated with a subscriber of the apparatus.

24. The method of claim 23, wherein the subscriber is associated with a subscribed NPN or a home public land mobile network, and wherein the configuration is received from the subscribed NPN or the home public land mobile network.

25. A non-transitory computer-readable medium storing a set of instructions for wireless communication, the set of instructions comprising:
one or more instructions that, when executed by one or more processors of an apparatus, cause the apparatus to:
receive a configuration indicating a set of non-public networks (NPNs), wherein the configuration includes at least one of:
a time condition for accessing the set of NPNs, or
a location condition for accessing the set of NPNs;
scan for the set of NPNs based at least in part on the configuration; and
register with an available NPN, of the set of NPNs, based at least in part on the time condition or the location condition being met for the available NPN.

26. The non-transitory computer-readable medium of claim 25, wherein the set of NPNs is a set of standalone NPNs (SNPNs), and wherein the one or more instructions, that cause the apparatus to scan for the set of SNPNs based at least in part on the configuration, cause the apparatus to:
scan for the set of SNPNs while in a public land mobile network (PLMN) access mode based at least in part on the time condition or the location condition being satisfied.

27. The non-transitory computer-readable medium of claim 26, wherein the one or more instructions further cause the apparatus to:
detect the available NPN based at least in part on the scanning; and
switch to an SNPN localized services mode, wherein registering with the available NPN is based at least in part on the SNPN localized services mode.

28. The non-transitory computer-readable medium of claim 27, wherein, in the SNPN localized services mode, the one or more instructions, when executed by the one or more processors of the apparatus, cause the apparatus to access only SNPNs of the set of SNPNs.

29. An apparatus for wireless communication, comprising:
means for receiving a configuration indicating a set of non-public networks (NPNs), wherein the configuration includes at least one of:
a time condition for accessing the set of NPNs, or
a location condition for accessing the set of NPNs;
means for scanning for the set of NPNs based at least in part on the configuration; and
means for registering with an available NPN, of the set of NPNs, based at least in part on the time condition or the location condition being met for the available NPN.

30. The apparatus of claim 29, wherein the set of NPNs is a set of standalone NPNs (SNPNs), and wherein the means for scanning for the set of SNPNs based at least in part on the configuration further comprises:
means for scanning for the set of SNPNs while in a public land mobile network (PLMN) access mode based at least in part on the time condition or the location condition being satisfied.
